(19) United States
(12) Patent Application Publication
(10) Pub. No.: US 2023/0287731 A1
(43) Pub. Date: Sep. 14, 2023

(54) IMPROVED FRAME SYSTEM FOR DOORS OR FIXED WINDOWS AND MODULAR COMPOSITE BAYS

(71) Applicant: BBG, S.A, Esposende (PT)

(72) Inventor: Bruno BRÁS, Esposende (PT)

(21) Appl. No.: 18/020,967

(22) PCT Filed: Jul. 15, 2021
(86) PCT No.: PCT/IB2021/056410

§ 371 Date: Feb. 13, 2023

(30) Foreign Application Priority Data
Sep. 18, 2020 (PT) 116745

(51) Int. Cl. E06B 3/56; E06B 3/263

(52) U.S. Cl. CPC E06B 3/56; E06B 3/263

(57) ABSTRACT

The present invention relates to an improved framing system for doors or windows, fixed panels and modular composite spans, by means of which an exterior minimalist aspect can be executed. It comprises: at least one fixed rim (7) and at least one movable panel (8) in which the glass (4) is glued, thus being part of the structural component of the movable panel (8) and making possible to manufacture larger spans, so that one can have, for example, larger swinging windows; fixation chambers for fixing squares (1), located in the fixed rim (7); polyamide thermal cutting elements (2); ironmongery (5) and elements for mechanically retaining the glass (4) from the outside of the movable panel. This structural innovation has advantages as eliminating the torsion of the monolithic panel block, optimising the system's mechanical behaviour, improving the functionality of the manoeuvring accessories and increasing the lifespan of the wearing accessories.

### FIELD OF THE INVENTION

The present invention falls within the technical scope of framing systems. More particularly, the present invention relates to framing systems adapted for inclusion in windows, doors, fixed panels and modular composite spans.

### BACKGROUND OF THE INVENTION

Nowadays, in the construction of opening, swinging or projecting frames, as they are commonly designated, the glass is inserted or laid down inside a movable panel. This assembly scheme implies that, for safety reasons, some structural limitations are imposed related to the dimensioning of a span and/or weight supported by each movable panel. The solutions known in the state of the art do not allow alternatives to the positioning of the glass, which must be laid down or inserted.

### SUMMARY OF THE INVENTION

The present invention consists of an improved framing system or improved frame for doors or windows and allows a glass (4) to be glued to a movable panel (8), instead of being merely laid down or inserted, thus becoming part of the structural component of the movable panel (8) and making it possible to manufacture larger spans. Therefore, the openings can reach dimensions of up to 5 m² and can also reach higher weights per movable panel (8), reaching up to 170 kg/panel for those operating in swing, internal opening, external opening and turn-and-tilt systems, and up to 350 kg/panel in the case of pivoting leaves with vertical axis (with mechanism hidden in the construction/reservation box).

Since the glass (4) becomes part of the structural component of the movable panel (8), because it is glued in the movable panel (8), it allows the aforementioned increase in dimension and weight and thus one can have, for example, larger swinging windows. This structural innovation, the gluing of the glass (4), has the additional advantage of eliminating the torsion of the monolithic panel block, which is a consequence of the assembly scheme of the state of the art. Furthermore, the present invention makes it possible to optimize the mechanical behaviour of the system and makes the functional performances more reliable by improving the functionality of the manoeuvring accessories, making it possible to extend the lifespan of the wearing accessories. The frame of the present invention makes use of a system of panel mounting squares, which results in linear integration in a single plane, successively and in this precise order, from the inside to the outside, and enabling a reduced size band, thus providing a size of the 18 mm range, and a reduction in the use of aluminium, apart from other advantages specified in the detailed description of the invention.

The frame system of the present invention guarantees an aesthetic aspect which is equivalent to steel frame products, allowing different configurations of the inner half-profile, both in double glass (not shown in the FIGURES) and in triple glass (shown in FIG. 1), thus resulting in an aesthetic approach to conventional steel profiles, namely L-shaped and corner profiles, and simultaneously guaranteeing exterior views compatible with the remaining offer as regards minimalist sliding systems of glued glass.

The frame system of the present invention is thus suitable for swinging or projecting doors or windows, making it possible to achieve a minimalist appearance from the outside with a central profile of reduced size, preferably 18 mm, making it possible to use the alignment offset of the external glass with the internal glass, creating a common central external profile of reduced size (preferably 18 mm), with improved thermal and acoustic performance, as well as water, air and wind permeability.

### DESCRIPTION OF THE FIGURES

FIG. 1—Representation of a horizontal section of the present invention showing a fixed rim (7), with mounting and alignment squares (1) without screws in the profile inner throat but with polyamides (2); the ironmongery (5) is represented; a movable panel (8), in which one can see the fixation chamber of the square (3) of the movable panel (8) (in this case with triple glazing) and its hidden fastening; the glazing (4) and fitting inner throat (6) of the glass panel (4) to the movable panel (8) are thus represented. The band (a) of 18 mm is also illustrated, which includes the linear integration in a single plane of the technology developed and visible from the outside, of a dimension (b) of 48 mm.

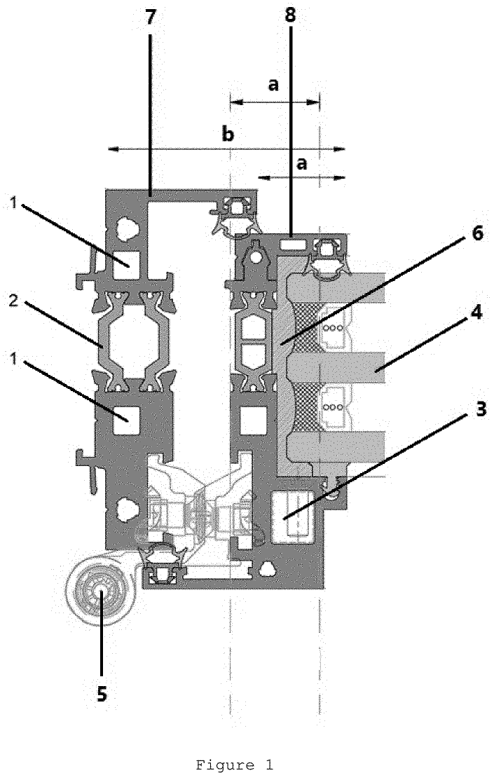

### DETAILED DESCRIPTION OF THE INVENTION

The present invention consists of an improved framing system for doors or windows, fixed panels and modular composite spans, and allows a glass (4) to be glued to a movable panel (8) instead of being only laid down or inserted, the glass (4) being, thus, part of the structural component of the movable panel (8) and allowing spans of larger dimensions to be manufactured, since the fixation is significantly improved. In this way, the spans can reach larger dimensions, increasing the size and weight, and one can have, for example, swinging windows of larger dimensions. Besides these structural improvements, one also has the additional advantage of eliminating the torsion of the monolithic panel block, optimising the mechanical behaviour of the system and making the functional performances more reliable by improving the functionality of the manoeuvring accessories, making it possible to increase the lifespan of the wearing accessories, as mentioned in the Summary of the invention.

Additional the frame system which is the object of this invention presents a structural configuration that allows an improvement in thermal performance, as it reduces the aluminium surface, optimizing thermal conductivity, increasing light transmission and improving the solar factor of the block. In terms of acoustic performance, the structural configuration of the system enables the maximisation of the glass area (4) and the reduction of parasitic air inlets. In terms of water permeability, an optimisation of the rim's decompression flow rates and reduction of water infiltration through the movable panel (8) is achieved by means of gluing. This new structural configuration also allows a reduction in the level of permeability through the monolithic block of the movable panel (8). In terms of mechanical resistance to wind action, the structural configuration herein presented increases the unit mass of the profiles, making it possible to use non-tubular profiles, leading to greater inertias and therefore lower deformations.

The structural configuration of the framing system the present invention is such that it allows a system with a movable panel (8) visible from the outside, wherein the dimension (b) can be of 48 mm in a fixed rim (7) plus the movable panel (8), which can be installed in a construction solution of interior or exterior insulation and in tunnel, presenting in the case of a fixed rim (7), concealed in the construction, an exterior perimeter view of reduced size, thus allowing a dimension of 18 mm, the latter corresponding to the exterior view on the movable panel (8).

The frame of the present invention uses a system of panel mounting squares, which results in the linear integration in a single plane, successively and in this precise order, from the inside to the outside, and allowing a band (a) of reduced dimension, thus providing a dimension of the 18 mm range.

The frame of the present invention can be applied in operative door or window spans of a building, the frame in this case consisting essentially of at least one fixed rim (7) and at least one movable panel (8), the said at least one movable panel (8) being glued to the glass (4) by its fitting inner throat (6).

This invention further comprises:
Fixation chambers for the fixing squares (1), these chambers being preferably parallel to the groove of the manoeuvring accessory and on an innermost side, with the mountings hidden by the glass chamber (4);
channel suitable for positioning and fixing one or more manoeuvring accessories on the movable panel (8) in an isolated chamber independent from the fixation chamber of the fixing square (1);
polyamide thermal cutting elements (2);
ironmongery (5);
glass (4) structurally bonded, preferably by application of high-strength bonding technology;
elements for mechanically retaining the glass (4) from the outside.

In a preferred embodiment, the frame of the present invention is further comprised of:
secondary and/or intermediate support squares (3); and/or
− squares for alignment and external anti-intrusion resistance.

In one embodiment, the present invention also includes an alignment band of the constructive components which includes the structural resistance, the thermal cutting and the manoeuvrability of the frame, all in a band of 18 mm. To this alignment band correspond specific squares, the fixing squares (1), the said alignment band being hidden and without visible screws on the perimeter of the movable panel (8). The square (1) is fixed through the inner glass neck (4), thus avoiding water infiltration in the movable panel (8), as arises from the assembly of leaves in the existing conventional ranges.

In one embodiment, the frame of the present invention includes, as previously mentioned, an external minimalist aspect, with a system of movable panel (8) visible from the outside and with a dimension (b) of 48 mm (fixed rim (7)+movable panel (8)) on an installation in internal or external insulation and in tunnel, that may present, in the case of a fixed rim (7), concealed in the construction, an external perimeter view of 18 mm, which corresponds to the external view on the movable panel (8). In the conventional frame solutions as existing in the market, the glass cloth is inserted into the collar of the panel profile or laid down and mechanically retained in the said profile by means of an additional retaining element (polymer or aluminium or steel profile). What is proposed with the present invention is that the glass, instead of being laid down and mechanically retained in the collar of the movable panel (8), is, by means of a gluing process, assembled on this structural element, thus guaranteeing the execution under maximum safety conditions of glazed spans of larger areas and a smaller deformation and torsion of the resulting monoblock, which is then comprised of the aluminium panel glued to a glass.

The frame that is the object of this invention is preferably manufactured in extrusion aluminium alloy profiles compatible with the construction sector.

In turn, these profiles are preferably nailed on polyamide elements reinforced with fiberglass, ensuring the thermal cutting for the manufacture of doors, windows, fixed panels and composite spans.

As will be evident to a person skilled in the art, the present invention should not be limited to the embodiments described herein, with a number of changes being possible, which remain within the scope of this invention. Of course, the preferred embodiments above described are combinable in the different possible forms, the repetition of all such combinations being herein avoided.

1. An improved framing system for doors or windows comprising at least a fixed rim (7) and at least one movable panel (8) wherein at least one movable panel (8) is glued to the glass (4) through its fitting inner throat (6).

2. The system according to claim 1 wherein it further comprises:
a) fixation chambers for fixing squares (1), located in the fixed rim (7);
b) a channel suitable for positioning and fixing at least one manoeuvring accessories of the movable panel (8) in an isolated chamber, the said channel being independent from the fixation chamber of the fixing squares (1);
c) polyamide thermal cutting elements (2);
d) ironmongery (5);
e) elements for mechanically retaining the glass (4) from the outside of the movable panel (8).

3. The system according to claim 2 wherein the fixation chambers for the fixing squares (1) are parallel to the groove of the manoeuvring accessory and, on an innermost side, with the mountings hidden by the glass chamber (4).

4. The system according to claim 3 wherein it comprises at least one secondary and/or intermediate support square (3) and/or at least one square for alignment and external anti-intrusion resistance.

5. The system according to claim 1 wherein it comprises an alignment band of the constructive components with 18 mm.

6. The system according to claim 5 wherein the alignment band is hidden and without visible screws on the perimeter of the movable panel (8).

7. The system according to claim 2 wherein the square (1) is fixed through a fitting inner throat (6) of the glass (4).

8. The system according to claim 1 wherein the visible size of the set comprised of the fixed rim (7) plus the movable panel (8), from the outside, is 48 mm.

9. The system according to claim 1 wherein the visible size of the external perimeter view of the fixed rim (7) is 18 mm and this view corresponds to the external view on the movable panel (8).

10. The system according to claim 1 wherein it is manufactured in extrusion aluminium alloy profiles.

11. The system according to claim 10 wherein that the profiles are nailed onto polyamide elements (2) reinforced with fiberglass.

12. The system according to claim 11 wherein it comprises single, double or triple glazing.
